(19) United States
(12) Patent Application Publication
(10) Pub. No.: US 2025/0338861 A1
(43) Pub. Date: Nov. 6, 2025

(54) Trimming Systems and Methods

(71) Applicant: Georgia Tech Research Corporation, Atlanta, GA (US)

(72) Inventors: Sean L. Thomas, Atlanta, GA (US); Aklilu Giorges, Atlanta, GA (US); Michael Park, Atlanta, GA (US)

(21) Appl. No.: 18/862,441

(22) PCT Filed: May 3, 2023
(86) PCT No.: PCT/US2023/066530

§ 371 Date: Nov. 1, 2024

Related U.S. Application Data
(60) Provisional application No. 63/364,059, filed on May 3, 2022.

(51) Int. Cl. A22B 5/00; A22C 21/00; B26D 5/08; B26D 7/18

(52) U.S. Cl. CPC A22B 5/0017; A22C 21/00; B26D 5/086; B26D 7/18

(57) ABSTRACT

A cutting system that may comprise a cutting tool and a motor. The cutting tool may comprise a first end wherein the first end may have a substantially hollow, cylindrically shaped, sharpened outer edge. The motor may be mechanically coupled to the cutting tool and can be configured to cause the first end of the cutting tool to rotate around a longitudinal axis of the first end. the system may further comprise a platform that can be configured to support an item to be cut. The item to be cut may be butterflied poultry. The platform may comprise a first side that can be configured to support a first side of the item to be cut, a second side that can be configured to support a second side of the item to be cut, and an apex that may be disposed between the first side and the second side.

### CROSS-REFERENCE TO RELATED APPLICATIONS

This application claims the benefit of U.S. Provisional Application Ser. No. 63/364,059, filed on 3 May 2022, which is incorporated herein by reference in its entirety as if fully set forth below.

### FIELD OF INVENTION

The various embodiments of the present disclosure relate generally to trimming/cutting systems and methods, and more particularly to systems and methods for trimming/cutting poultry in poultry processing plants

### BACKGROUND

Today's poultry processing plants have at least five workers trimming fat and bone off the butterflied poultry after it has been removed from the front half. With the line running at almost 50 birds per minute, workers perform inaccurate and imprecise cuts to remove leftover bone and fat from the butterfly removal process. The outcome is a high rate of yield loss (>10%) which adds up to high losses for the processing plants. Accordingly, there is a need for improved systems and methods for trimming butterflied poultry to reduce yield loss.

### SUMMARY

An exemplary embodiment of the present disclosure provides a cutting system that may comprise a cutting tool and a motor. The cutting tool may comprise a first end wherein the first end may have a substantially hollow, cylindrically shaped, sharpened outer edge. The motor may be mechanically coupled to the cutting tool and can be configured to cause the first end of the cutting tool to rotate around a longitudinal axis of the first end.

In any of the embodiments disclosed herein, the system may further comprise a platform that can be configured to support an item to be cut. The item to be cut may be butterflied poultry. The platform may comprise a first side that can be configured to support a first side of the item to be cut, a second side that can be configured to support a second side of the item to be cut, and an apex that may be disposed between the first side and the second side. The apex may form a hinge between the first side of the platform and the second side of the platform.

In any of the embodiments disclosed herein, the cutting tool may further comprise one or more gears that can configured to cause rotation of the first end upon engagement of the one or more gears by the motor.

In any of the embodiments disclosed herein, the cutting tool may further comprise one or more belts configured to cause rotation of the first end upon engagement of the one or more belts by the motor.

In any of the embodiments disclosed herein, the cutting tool may further comprise one or more coils configured to cause rotation of the first end upon engagement of the one or more coils by the motor.

In any of the embodiments disclosed herein, the motor may be a variable speed motor. The motor may be a pneumatic driven motor. The motor may be an electric motor.

In any of the embodiments disclosed herein, the cutting tool may further comprise an adjustable depth gauge configured to adjust a depth of a cut made by the cutting tool. The adjustable depth gauge may comprise a roller that can be configured to determine the depth of a cut made by the cutting tool.

In any of the embodiments disclosed herein, the cutting tool may further comprise a pneumatic nozzle that can be configured to eject one or more trimmed portions of the butterflied poultry. The cutting tool may further comprise a pressure differential valve configured to eject one or more trimmed portions of the butterflied poultry. The cutting tool may further comprise a passive auger that can be configured to eject one or more trimmed portions of the butterflied poultry.

In any of the embodiments disclosed herein, the cutting tool can be fixed on a frame. The cutting tool can be a handheld cutting tool.

Another embodiment of the present disclosure provides a method for cutting an item, the method may comprise providing a cutting system, activating the motor of the cutting system to rotate the first end of the cutting tool, and cutting a portion of the item.

In any of the embodiments disclosed herein, the item may be butterflied poultry and the method can further comprise placing a first side of the butterflied poultry on a first side of a platform, placing a second side of the butterflied poultry on a second side of the platform, and placing a mid-section of the butterflied poultry on an apex of the platform. The apex can be disposed between the first and second sides of the platform. The apex can form a hinge between the first side of the platform and the second side of the platform.

In any of the embodiments disclosed herein, the method may further comprise determining a desired depth of a cut into the item utilizing the cutting tool. Determining a desired depth of a cut into the item utilizing the cutting tool may comprise, measuring the depth of the cut into the item utilizing an adjustable depth gauge. The cutting tool may comprise the adjustable depth gauge. The adjustable depth gauge may comprise a roller that can be configured to determine the depth of the cut made by the cutting tool.

In any of the embodiments disclosed herein, the cutting system may comprise one or more gears configured to cause rotation of the first end of the cutting tool upon engagement of the one or more gears by the motor.

In any of the embodiments disclosed herein, the cutting system may comprise one or more belts configured to cause rotation of the first end of the cutting tool upon engagement of the one or more belts by the motor.

In any of the embodiments disclosed herein, the cutting system may comprise one or more coils that can be configured to cause rotation of the first end of the cutting tool upon engagement of the one or more coils by the motor.

In any of the embodiments disclosed herein, the motor can be a variable speed motor.

In any of the embodiments disclosed herein, the motor can be a pneumatic driven motor. In any of the embodiments disclosed herein, the motor can be an electric motor.

In any of the embodiments disclosed herein, the method may further comprise expelling a cut portion of the item from the cutting tool.

In any of the embodiments disclosed herein, expelling a cut portion of the item from the cutting tool may include ejecting the cut portion of the item from the cutting tool using a pneumatic nozzle to remove the portion of the item. The cutting tool may comprise the pneumatic nozzle.

In any of the embodiments disclosed herein, expelling a cut portion of the item from the cutting tool may comprise ejecting the cut portion using a pressure differential valve to remove the portion of the item. The cutting tool may comprise the pressure differential valve.

In any of the embodiments disclosed herein, expelling a cut portion of the item from the cutting tool may comprise ejecting the cut portion of the item from the cutting tool using a passive auger to remove the portion of the item. The cutting tool may comprise the passive auger.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF DRAWINGS

The above and further aspects of this invention are further discussed with reference to the following description in conjunction with the accompanying drawings, in which like numerals indicate like structural elements and features in various figures. The drawings are not necessarily to scale, emphasis instead being placed upon illustrating principles of the invention. The figures depict one or more implementations of the inventive devices, by way of example only, not by way of limitation.

FIG. 1 is a computer aided design (CAD) illustration of a handheld embodiment of a cutting system in accordance with some exemplary embodiments of the present disclosure.

FIG. 2 is an illustration of a cutting system performing a cut on an item, the item being butterflied poultry, on a platform in accordance with some exemplary embodiments of the present disclosure.

FIG. 3 is an illustration of a cutting system fixed within a frame with a platform in accordance with some exemplary embodiments of the present disclosure.

FIG. 4 is a flow chart for a method of utilizing a cutting system to perform a cut on an item in accordance with some exemplary embodiments of the present disclosure.

### DETAILED DESCRIPTION

The following detailed description should be read with reference to the drawings, in which like elements in different drawings are identically numbered. This description enables one skilled in the art to make and use the invention, and describes several embodiments, adaptations, variations, alternatives and uses of the invention, including what is presently believed to be the best mode of carrying out the invention. Any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those skilled in the pertinent art in view of the teachings herein. Such modifications and variations are intended to be included within the scope of the claims.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

By “comprising” or “containing” or “including” is meant that at least the named compound, element, particle, or method step is present in the composition or article or method, but does not exclude the presence of other compounds, materials, particles, method steps, even if other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

For exemplary and illustrative purposes, the cutting system 100 disclosed within the present disclosure may be contemplated in applications within poultry processing. It should be appreciated, however, that the present disclosure is not so limited. The cutting system may be leveraged in applications such as the trimming of biological materials beyond meat product, surgical applications, other food applications, and the like that may require a cutting system to trim a portion of an item 202.

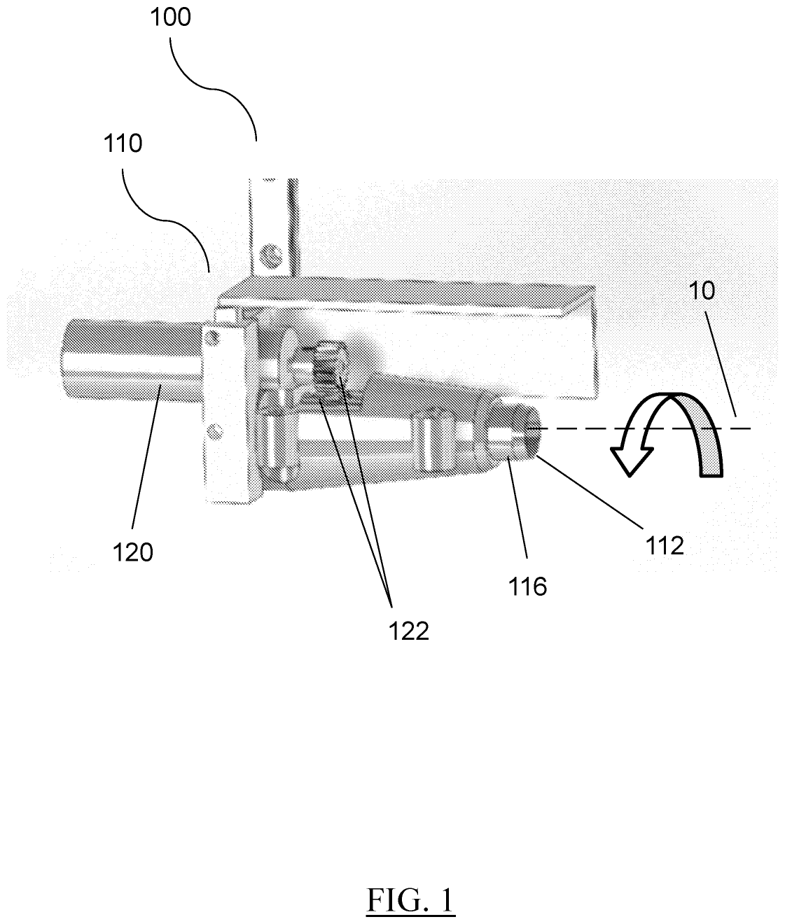

FIG. 1 is a computer aided design (CAD) illustration of the cutting tool 110 of the cutting system 100. As shown in FIG. 1, the cutting tool 110 may include a first end 116 that can have a cylindrically shaped, sharpened outer edge 112. As shown in FIG. 1, the first end 116 can be substantially hollow. As explained below, the hollow shape of the first end 116 can allow trimmed/cut portions of the item to pass therethrough. The sharpened outer edge of the first end 116 of the cutting tool 110 can be made of many different materials known in the art. In some embodiments, the blade is made of stainless steel. The cutting system 100 may also include a motor 120 that can be mechanically coupled to the cutting tool 110, which is also pictured in FIG. 1, and can be configured to cause the first end 116 of the cutting tool 110 to rotate about a longitudinal axis 10 of the first end. As one skilled in the art will appreciate, the speed of rotation, which can be measured in rotations per minute (RPMs), of the sharpened outer edge first end 116 of the cutting tool may be modulated based on the speed of the motor 120. As one skilled in the art may also appreciate, the RPMs that can be achieved based on the speed of the motor 120 may determine the efficiency and depth of that the cutting tool 110 can cut into an item 202. In some embodiments, the types of motors 120 that may be used with the cutting tool 110 can include but not be limited to a variable speed motor, a pneumatic motor, an electric motor, and the like.

The cutting tool can achieve rotation of the first end many different ways, as would be appreciated by those skilled in the art. As shown in FIG. 1, in some embodiments, the cutting tool 110 may also include one or more gears 122 that can be configured to cause rotation of the first end, with respect to the longitudinal axis 10, upon engagement of the one or more gears 122 by the motor 120. It should be appreciated that the motor 120, as pictured in FIG. 1, may have a set of teeth that can cooperatively engage the set of teeth on the one or more gears 122. It should also be appreciated that sizing of the gears for the motor 120 and the one or more gears 122 may be designed to increase or decrease RPMs for the first end 116 of the cutting tool 110, which can thereby impact the depth and efficiency of the cut that may be performed by the cutting tool 110. Design considerations for the cutting tool 110 can include modulating the diameter of the first end 116, which can be advantageous for particular applications that may require greater depth or efficiency of cuts given the item's 202 profile, texture or hardiness. Alternatively or in addition to the gears, in some embodiments, the cutting tool 110 may include one or more belts or one or more coils that can be configured to cause rotation of the first end 116, about the longitudinal axis 10 of the cutting tool 110.

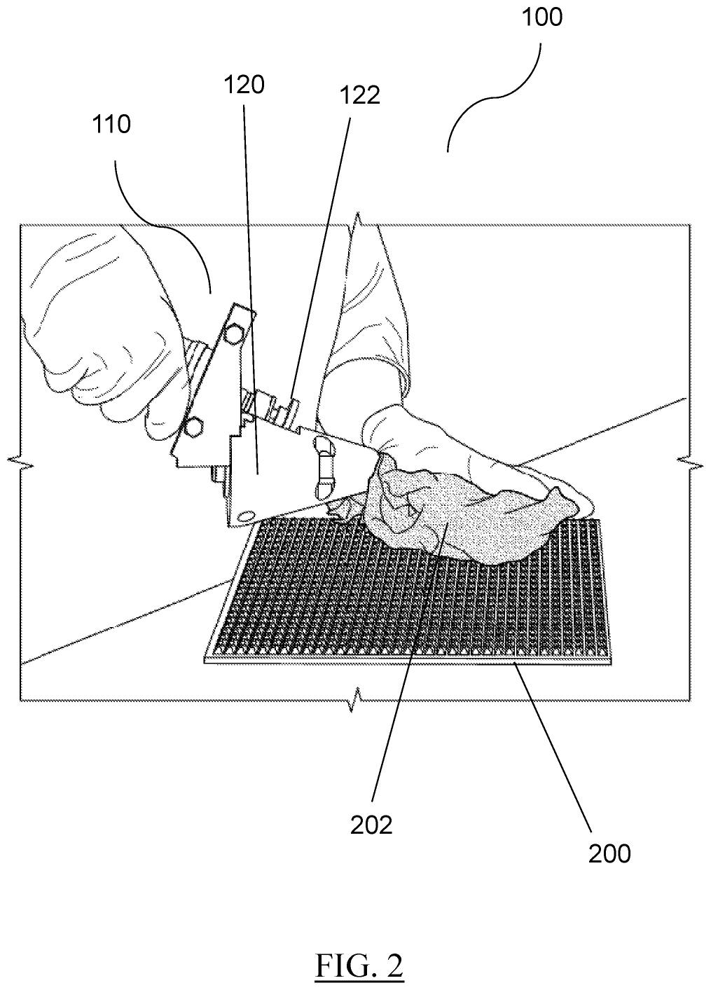

FIG. 2 is photograph of a cutting tool 110 of the cutting system 100 performing a cut on an item 202 on a platform 210. In some embodiments, as shown in FIG. 2, the item 202 cut/trimmed by the cutting tool 110 may be butterflied poultry. The cutting system 100 may also include a platform 200, as shown in FIG. 2, that can be used to support an item 202 to be cut, such as butterflied poultry. For poultry applications, the cutting tool 110 may be used to remove unwanted fat, bone, and cartilage from the butterfly and other parts of poultry that require trimming. In some embodiments, the unwanted fat, bone, and cartilage from the butterflied poultry, once cut, may travel through the substantially hollow first end 116 of the cutting tool 110 and can be expelled through the back. Other ways in which the cutting tool 110 may eject trimmed portions of the butterflied poultry can include but not be limited to pneumatic nozzle, pressure differential valve, a passive auger, and the like.

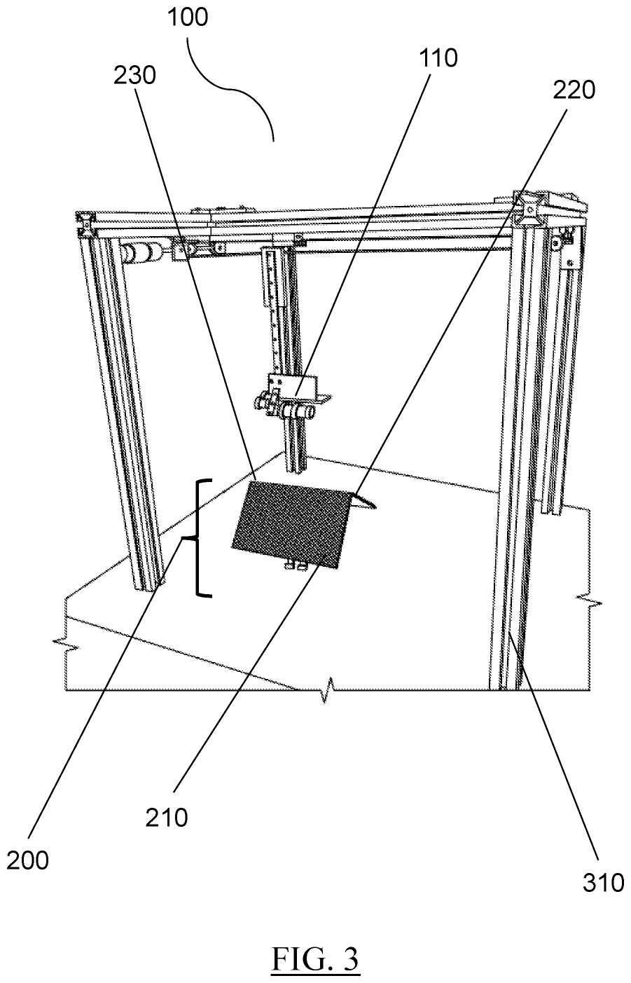

FIG. 3 is an embodiment of the cutting system an embodiment of the cutting tool of the cutting system fixed within a frame with a platform. In a poultry processing application, the cutting tool 110 of the cutting system 100 fixed within a frame 310, as shown in FIG. 3. The frame may be configured to move the cutting tool in three degrees of freedom, which can be advantageous as it can be positioned over an assembly line of poultry product that may all require a specific cut by the cutting tool 110. In some embodiments, the platform 200 may resemble an inverted V-shape with a first side 210 configured to support the first side of an item 202, a second side 220 that can be configured to support a second side of an item 202, and an apex 230 that may be disposed between the first and second side, as shown in FIG. 3. For poultry processing applications, the platform 200 having an inverted V shape may be advantageous to help make the center of the butterfly poultry more accessible for the cutting tool 110 to remove the unwanted fat, bone, and cartilage from the butterfly poultry.

In the fixed frame embodiment of the cutting system 100, illustrated in FIG. 3, the cutting tool 110 may also include an adjustable depth gauge that can be configured to adjust a depth of a cut made by the cutting tool 110. The adjustable depth gauge may also include a roller that can be configured determine the depth of a cut made by made by the cutting tool 110. Utilization of the adjustable depth gauge and roller within the fixed embodiment of the cutting system 100 can be advantageous for automation application. Specifically, the adjustable depth gauge and roller can allow the cutting system 100 to perform identical cuts to items 210 translated upon an assembly line, such as in poultry processing. As one skilled in the art will appreciate, gauging the depth of cuts made by the cutting tool 110 in poultry applications can be advantageous as it can preserve higher proportions of butterfly poultry and therein promote increases in overall product yield.

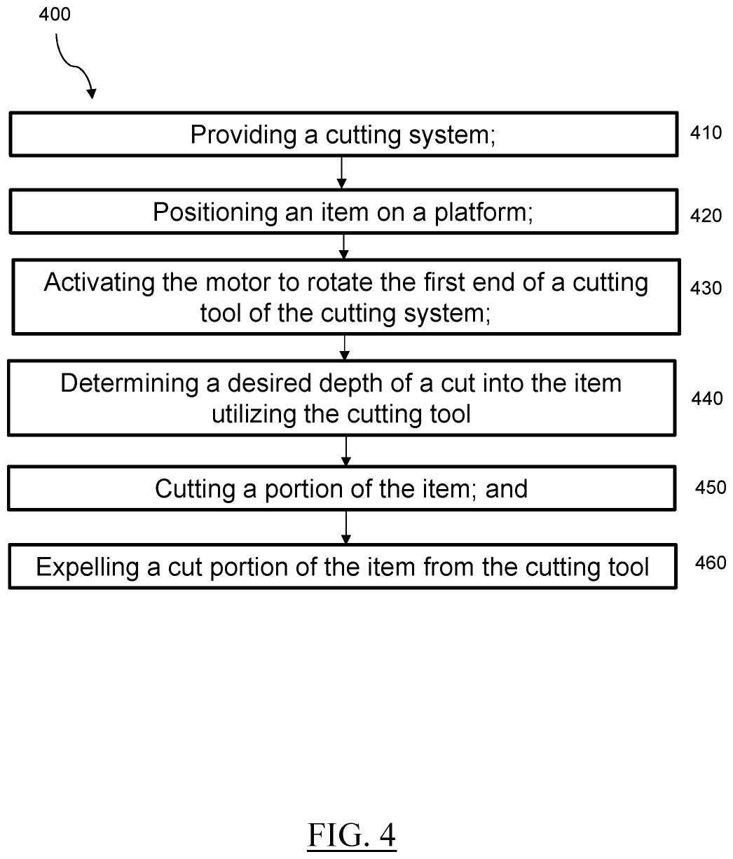

FIG. 4 is method flow chart for utilizing the cutting system 100 to perform a cut on an item 202. The method 400 to perform a cut on an item 202 using the cutting system 100 may include method step 410 of providing a cutting system 100. The cutting system 100 of claim 1, as mentioned previously, may include a cutting tool 110 and a motor 120. The cutting tool 110 may include a first end 116 wherein the first end 116 can have a substantially hollow, cylindrically shaped, sharpened outer edge. The motor 120 may be mechanically coupled to the cutting tool and can be configured to cause the first end of the cutting tool to rotate around a longitudinal axis 10 of the first end 116. It should be appreciated that the embodiments of the cutting system 100 shown in FIGS. 1 and 3 are contemplated in method step 410.

The next method step 420 may include positioning an item 202 on a platform 200 wherein the item 202 is butterflied poultry. In some embodiments, the positioning an item 202 on a platform 200 wherein the item 202 is butterflied poultry may include placing a first side of the butterflied poultry on a first side 210 of the platform 200, placing a second side of the butterflied poultry on a second side 220 of the platform 200, and placing a mid-section of the butterflied poultry on an apex 230 of the platform 200. It should be appreciated that the apex is disposed between the first and second sides of the platform.

The next method step 430, as shown in FIG. 4, may include activating the motor 120 to rotate the first end 116 of the cutting tool 110. In some embodiments, the motor 120 may rotate the first end 116 of the cutting tool 110 via engagement of one or more gears 122 by the motor 120 to cause rotation of the first end 116 of the cutting tool 110. It should be appreciated that the cutting system 100 may include the one or more gears 122. In some embodiments, the motor 120 may rotate the first end 116 of the cutting tool 110 via engagement of one or more belts by the motor 120 to cause rotation of the first end 116 of the cutting tool 110. It should be appreciated that the cutting system 100 may include the one or more belts. In some embodiments, the motor 120 may rotate the first end 116 of the cutting tool 110 via engagement of one or more coils by the motor 120 to cause rotation of the first end 116 of the cutting tool 110. It should be appreciated that the cutting system may include one or more coils.

The method 400 may further comprise method step 440 which can comprise determining a desired depth of a cut into the item 202 utilizing the cutting tool. The method step 440 can further include measuring the depth of the cut into the item utilizing an adjustable depth gauge. In some embodiments, the adjustable depth gauge may include a roller that can be configured to determine the depth of the cut made by the cutting tool 110. It should be appreciated that the cutting tool 110 may include the adjustable depth gauge.

In some embodiments, the method 400 may further comprise method step 450 which can include cutting a portion of the item 202. For example, the first end 116 of the cutting tool 110 may spin at a high RPM upon activation of the motor 120. The high RPM can allow the cylindrically shaped, sharpened outer edge of the cutting tool 110 to incise the item 202 to be cut. The next method step 460 can include expelling a cut portion of the item from the cutting tool. In some embodiments, expelling the cut portion of the item 202 from the cutting tool 110 may comprise ejecting the cut portion of the item 202 from the cutting tool 110 using a pneumatic nozzle to remove the cut portion of the item 202, wherein the cutting tool 110 may include the pneumatic nozzle. In some embodiments, ejecting the cut portion of the item 202 from the cutting tool 110 may comprise ejecting the cut portion of the item 202 from the cutting tool 110 using a pressure differential valve to remove the cut portion of the item 202, wherein the cutting tool 110 may include the pressure differential valve. In some embodiments, ejecting the cut portion of the item 202 from the cutting tool 110 may comprise ejecting the cut portion of the item 202 from the cutting tool 110 using a passive auger to remove the cut portion of the item 202, wherein the cutting tool 110 may include the passive auger.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A cutting system comprising:
a cutting tool comprising a first end;
a platform configured to support an item to be cut; and
a motor mechanically coupled to the cutting tool and configured to cause the first end of the cutting tool to rotate around a longitudinal axis of the first end.

2. The system of claim 1, wherein the cutting tool further comprises at least one of:
a pressure differential valve configured to eject one or more trimmed portions of the item; or a passive auger configured to eject one or more trimmed portions of the item.

3. The system of claim 2, wherein the item to be cut is butterflied poultry.

4. The system of claim 2, wherein the first end of the cutting tool has a substantially hollow, cylindrically shaped, sharpened outer edge.

5. The system of claim 4, wherein the platform comprises:
a first side configured to support a first side of the item to be cut;
a second side configured to support a second side of the item to be cut;
and an apex disposed between the first side and the second side;
wherein the apex forms a hinge between the first side of the platform and the second side of the platform.

6. The system of claim 4, wherein the cutting tool further comprises at least one of:
one or more gears configured to cause rotation of the first end upon engagement of the one or more gears by the motor;
one or more belts configured to cause rotation of the first end upon engagement of the one or more belts by the motor; or
one or more coils configured to cause rotation of the first end upon engagement of the one or more coils by the motor.

7.-8. (canceled)

9. The system of claim 4, wherein the motor is selected from a group consisting of a variable speed motor, a pneumatic driven motor, and an electric motor.

10.-11. (canceled)

12. The system of claim 4, wherein the cutting tool further comprises at least one of:
an adjustable depth gauge configured to adjust a depth of a cut made by the cutting tool; or
a pneumatic nozzle configured to eject one or more trimmed portions of the item.

13. The system of claim 12, wherein the adjustable depth gauge comprises a roller configured to determine the depth of a cut made by the cutting tool.

14.-16. (canceled)

17. The system of claim 4, wherein the cutting tool is fixed on a frame.

18. The system of claim 4, wherein the cutting tool is a handheld cutting tool.

19. A comprising:
activating the motor of the cutting system of claim 4 to rotate the first end of the cutting tool; and
cutting the item.

20. The method of claim 19 further comprising:
positioning the item on the platform;
wherein the item is butterflied poultry.

21. The method of claim 19 further comprising:
placing a first side of the item on a first side of the platform;
placing a second side of the item on a second side of the platform; and
placing a mid-section of the item on an apex of the platform;
wherein the apex forms a hinge between the first side of the platform and the second side of the platform.

22. The method of claim 19 further comprising:
measuring a desired depth of a cut into the item utilizing an adjustable depth gauge of the cutting tool.

23. The method of claim 22, wherein the adjustable depth gauge comprises a roller configured to determine the depth of the cut made by the cutting tool.

24. The method of claim 19, wherein the cutting system further comprises at least one of:
one or more gears configured to cause rotation of the first end of the cutting tool upon engagement of the one or more gears by the motor;
one or more belts configured to cause rotation of the first end of the cutting tool upon engagement of the one or more belts by the motor; or
one or more coils configured to cause rotation of the first end of the cutting tool upon engagement of the one or more coils by the motor.

25.-26. (canceled)

27. The method of claim 19, wherein the motor is selected from a group consisting of a variable speed motor, a pneumatic driven motor, and an electric motor.

28.-29. (canceled)

30. The method of claim 19, wherein the cutting tool further comprises a pneumatic nozzle.

31.-32. (canceled)
